(19) United States
(12) Patent Application Publication
(10) Pub. No.: US 2010/0228591 A1
(43) Pub. Date: Sep. 9, 2010

(54) REAL TIME AD SELECTION FOR REQUESTED CONTENT

(76) Inventors: Madhusudan Therani, San Jose, CA (US); Vinod Viswanathan, Cupertino, CA (US); Roshan Kumar, Santa Clara, CA (US)

Correspondence Address: CARR & FERRELL LLP, 2200 GENG ROAD, PALO ALTO, CA, 94303, US

(21) Appl. No.: 12/396,931

(22) Filed: Mar. 3, 2009

(51) Int. Cl. G06Q 30/00; G06Q 99/00

(52) U.S. Cl. 705/10; 705/14.53

(57) ABSTRACT

Media is provided to a client device in response to a request with dynamically selected advertisements in near real time by performing a portion of ad selection operations as pre-processing before a media content request is received. One or more advertisements can be dynamically selected by an application server based on user data, advertisement parameters and other data to provide in the requested media. Attributes can be determined for one or more advertisement sets in which advertisements are placed within the requested media. The advertisement sets may be configured with the identified advertisements by an application server, and the requested media content and identified ads can be provided to the requesting client device.

### CROSS REFERENCE TO RELATED APPLICATIONS

This application is related to U.S. nonprovisional patent application number ______, titled “ENTERTAINMENT SERVICE FOR PROVIDING PERSONALIZED ADVERTISEMENTS” and filed on Mar. 3, 2009, the disclosure of which is incorporated herein by reference.

### BACKGROUND

Traditional media content providers such as television broadcasters and internet networks provide content on behalf of an artist, author, or production house. In some systems, an intermediary acquires content from the content provider and often negotiates broadcasting terms with an intermediary broadcaster or network provider/content owner who then negotiates with resellers and advertisers based on content provided by the network or system. Acquired content and associated advertising is typically pushed to a group of users via channels controlled by the intermediary or network service provider. The advertising is typically chosen to match the content, content popularity, and/or user groups thought to view such content. This is commonly known as the push model.

Some systems allow a user to choose specific items of content. For example, internet-based services allow a user to choose a desired song to be downloaded from the internet and/or order a desired movie or TV show for viewing. Such systems typically require the a priori knowledge of which item of content is desired. For example, a user may wish to choose from among thousands of movies, thousands of TV shows, hundreds of thousands of songs, millions of web pages, or other large numbers of media items. This is commonly known as the pull model.

Existing systems that push media content provide a limited system for delivering content to a user in an efficient and cost-effective manner, do not provide the advertiser with a cost effective manner, or a manner by which the advertiser can verify with certainty, that a user, or group of users has actually viewed the ad, nor can the advertiser target specific users, or user groups, based on a set of parameters, or allow the users to determine themselves which advertisements they want to view, and as a result cost the user, advertisers and entertainment service partners time and money.

### SUMMARY

The technology described herein pertains to an interactive media based entertainment service that provides user requested media and products to a user and in addition may recommend non-user requested interactive media and related product offers that match user preferences and viewing usage behavior patterns. Video, audio, images, products, services and other media may be provided to a user for a fee or free of charge, or any combination of both. The media may be provided from the service provider to a client device over a network. When providing media without charge, the entertainment service can incorporate one or more ads into, surrounding or near the media. The ads may be targeted to the user, media content, and other features using advertisement parameters.

Advertisements are provided to a user based on a combination of user preference and other user information as well as advertising parameters. Ads can be inserted into requested video content or in an ad on demand service. The ad may be inserted into the video content as part of one or more ad sets. An ad set, or a commercial break, contains one or more ads. The ad sets can be configured for a particular piece of video content with attributes such as number of ad sets, length and position within the content, and other attributes which are determined dynamically. Ads may also be viewed through an ad on demand user interface. The ad on demand user interface can provide previously played ads as well as ads selected for a user.

An embodiment can provide media to a client device by identifying potential ads at an application server for each user in a set of users. The application server can also identify potential ads for each element of media content in a set of media content. A request can then be received for media content from a client device by the application server. A subset of the potential ads may be identified based on the media content request received from the client. The requested content and the subset of potential ads may be provided to the client device. A computer readable storage medium may have a program being executable by a processor to perform the method.

An embodiment includes a system for providing media to a client device. The system includes an application server, a plurality of media streaming servers, and a local data server. The application server can receive media content and transmit the media content to at least one of the media streaming servers. The media streaming servers are coupled to the application server and a client device. The media streaming servers are configured to stream media content in response to receiving a media content request from a client device. The local data server is also coupled to the application server, and is configured to receive media data, ad data and user data from the client device. The local data server is configured to insert selected advertisements into requested media content satisfying relationships between media content, users, and advertisements represented as on ordered binary decision diagrams.

### BRIEF DESCRIPTION OF THE DRAWINGS

FIG. 1A is a block diagram of an exemplary system for providing an entertainment service to a user.

FIG. 1B is a block diagram of an exemplary system for communicating content and data to a client device.

FIG. 2 is a flow chat of an exemplary method for providing content to a user.

FIG. 3 is a flow chart of an exemplary method for performing advertisement selection pre-processing.

FIG. 4 is a flow chat of an exemplary method for providing content to a user at runtime.

FIG. 5 illustrates a logical representation of an ad set configuration.

FIG. 6 is a flow chart of an exemplary method for determining ad set attributes.

FIG. 7 is a block diagram of an exemplary computing device.

### DETAILED DESCRIPTION

The technology described herein pertains to an interactive media based entertainment service that provides user requested media and products to a user and in addition may recommend non-user requested interactive media and offers that match user preferences and viewing usage behavior patterns. Video, audio, images, products, services and other media may be provided to a user for a fee or free of charge, or any combination of both. The media may be provided from the service provider to a client device over a network. When providing media without charge, the entertainment service can incorporate one or more ads into, surrounding or near the media. The ads may be targeted to the user, media content, and other features using advertisement parameters.

Advertisements are provided to a user based on a combination of user preferences, demographic data, behavior data, and other user data, advertisement parameters, content meta-data, and other data. Ads can be inserted into requested video content or in an ad on demand service. The ad may be inserted into the video content as part of one or more advertisement sets or “pods.” An ad set can contains one or more ads. The ad sets can be configured for a particular piece of video content with attributes such as number of ad sets, length and position within the content, and other attributes which are determined dynamically. Ads may also be viewed through an ad on demand user interface. The ad on demand user interface can provide previously played ads as well as ads selected for a user.

Examples may be referred to herein related to receiving a request for video content, providing selected advertisements in the requested video, and providing the requested video and selected advertisements to a requesting client. These media specific discussions are intended as examples only. The technology and systems discussed here are intended to work with different types of media, including audio, animation, images, and other media, and any specific reference to video or any other media is strictly for purposes of example.

In some embodiments, portions of the ad selection process can be performed ahead of time, or before a request for the media content is received. By performing some of the ad selection related operations as pre-processing, the present system may provide requested media with dynamically selected ads, customized for the user requesting the content, in near real time with minimal delay.

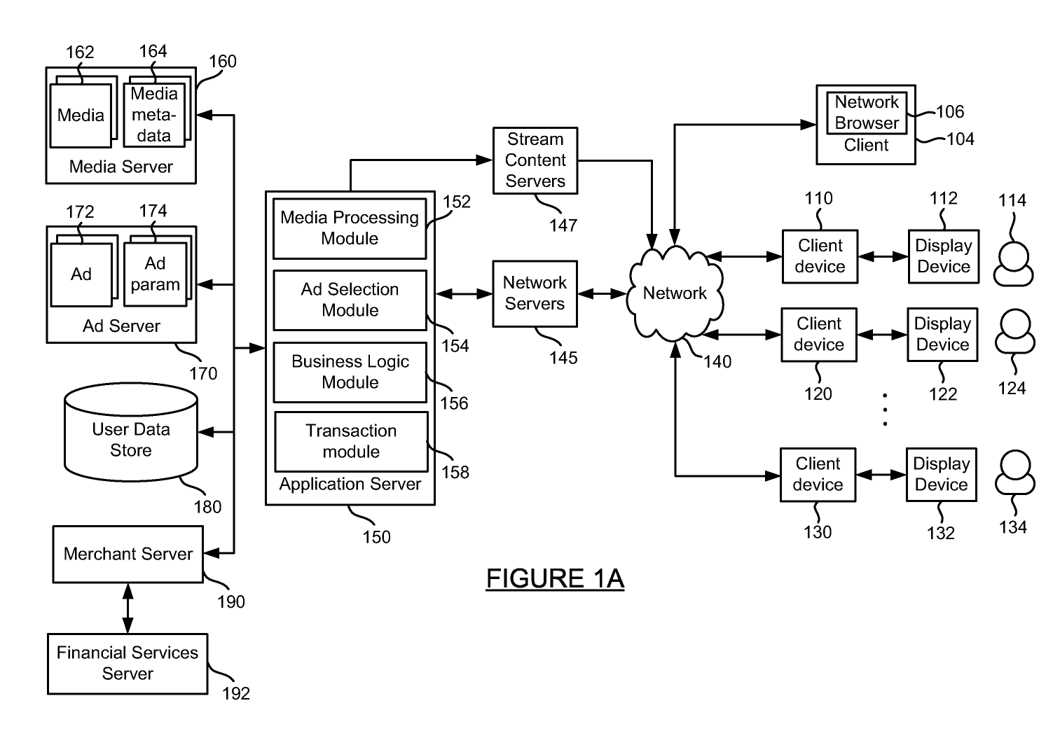

FIG. 1 is a block diagram of an exemplary system for providing an entertainment service to a user. The system of FIG. 1 includes a system of servers in communication with a system of client devices over a network. Client devices 110, 120 and 130 communicate with display devices 112, 122 and 132, respectively. Users 114, 124 and 134 are associated with each display device and client device combination, respectively. For example, a user 114 may provide input to client device 110 to retrieve and playback video content through display device 112. In some embodiments, the media service discussed herein is implemented by application server 150 and network server 145. In some embodiments, the system providing media service can also include any of servers 160-190.

Client 104 is coupled to network 140 and may include network browser 106. Network browser 106 may request, receive and provide network content such as a web page. For example, a user may access a media service provided over network 140 through network browser application 106.

Client devices 110-130 and client 104 are coupled to network 140. In some embodiments, each of client devices 110-130 may be implemented as a set-top box which provides content through a viewer user interface. An exemplary set-top box is disclosed in U.S. patent application Ser. No. 12/360,007, entitled “Set-Top Box,” filed on Jan. 26, 2009, the disclosure of which is incorporated herein by reference. Other devices may embed the technology directly, including but not limited to television sets, mobile devices, gaming consoles, watches, phones, and digital cameras.

Network 140 can facilitate communication between network server 145, client 104 and client devices 110-130. Network 140 may be implemented as the Internet or other WAN, a LAN, intranet, extranet, private network or a combination of networks.

Network server 145 can include one or more servers and communicates with application server 150 and network 140. Network server 145 can be implemented as a web server that operates as an intermediary server between application server 150 and network 140. For example, network server 145 may be a web server or application web server that receives requests from client devices 104, 110, 120 and 130, processes and forwards the requests to application server 150, and sends a response generated by application server 150 to the requesting client device.

Application server 150 communicates with network server 145, can include one or more servers, and includes logic which implements the media service of the present technology. Application server 150 can include media processing module 152, ad selection module 154, business logic module 156 and transaction module 158. Each of the modules 152-158 can be implemented on a different application server or backend server, such as servers 160-190. Other modules and logic may be incorporated on application server in addition to those illustrated in FIG. 1.

Media processing module 152 may receive, encode, and transmit video, audio, images and other media to client devices 104 and 110-130 through network server 145. The media may be transmitted as a complete file, a streaming data such as streaming video, or in some other format. Media processing module 152 may incorporate selected advertisements received from or identified by ad selection module 154 within video media and transmit the video media with the incorporated ads.

Ad selection module 154 may access advertisement media and advertisement parameters from ad server 170. The ad parameters specify how ads can be incorporated into a particular media file by media processing module 152. The parameters can indicate a user gender, geographic location, income level, marriage status, or other user demographic data, as well as user viewing behavior, purchase behavior, and other user data, or the ad may be selected directly by the user. The ad parameters may also specify content categories, brand adjacency, frequency requirements, cost information, and other display rules for providing the ad to a user.

Business logic module 156 may handle various business logic and processing rules associated with the media service. For example, business logic module 156 may handle user loyalty and reward programs which reward a user for certain viewing behavior and interaction with advertisements. Business logic module 156 may also retrieve and manage user data contained in user data store 180 and determine revenue distribution among different participants in a media service ecosystem, such as users, advertisers, content providers, merchants, network service provider companies (cable companies, power companies, telephone companies, and so forth), and other groups.

Transaction module 158 may facilitate commerce transactions between a client device and merchant server 190. Facilitating a purchase transaction allows a user to purchase goods or service associated with an advertisement through the media service.

Application server 150 may transmit content through stream content servers 147. In some embodiments, stream content servers 147 may include one or more servers configured to stream content to several client devices. For example, stream content servers 147 may include a host stream device which receives media and advertising content. The host stream device may provide content to one or more streaming servers which establish connections with a client device and stream media content, including requested and recommended media as well as advertisements, to the client.

Application server 150 may communicate with media server 160, ad server 170, user data store 180, and merchant server 190. Media server 160 may store media 162 and related information, including metadata 164 for stored media, which may be retrieved by application server 150. Media 162 may comprise movies, TV episodes, offers, and other video, as well as audio and image media, interactive media and application services such as two-way Voice Over Internet Protocol (VOIP) telephony, two-way video and other interactive applications. Media metadata 164 may include information associated with each piece of media or an offer, such as a media category (i.e., sports, documentary, family, and so forth), media length, potential breaks within the media for inserting ads, cost of playback for media, and other data associated with the media.

Ad server 170 can communicate with application server 150 and may include one or more advertisements 172 as well as advertisement parameters 174 associated with each ad. Advertisements 172 may be associated with a company, product, service or some other topic of potential interest for a user. The ad parameters indicate to whom a particular ad should or is required to be provided to, as well as cost information, timing information and other ad requirements. Ad parameters may be configured for an advertisement by an advertiser with preferred and required parameters for matching an ad to a combination of a user data (including user demographic data), media content, and time.

User data store 180 can communicate with application server 150 and data for users having an account with the media service. User information may include, for each of one or more users, user demographic information, user behavior information, user content preferences, and other user information. Use demographic information may include information that a user provides to the service, such as a user's gender, marital status, income, ethnic background, and other data. User behavior information may include information associated with past user behavior observed by the entertainment service. User content preferences may include one or more categories of media content that a user has indicated are preferable to the user. Examples of preferred content categories may include news, sports, movies, television shows, one or more types of genres, and other information.

Merchant server 190 handles purchases requested by a user through client device 130. Merchant server 190 may be associated with an e-commerce service, a particular service or product provider, or some other organization. Merchant server 190 may communicate with one or more banks or credit card, credit card processing services, merchant gift cards, pre-paid merchant cards, or other financial services as represented by financial server 192.

FIG. 1B is a block diagram of an exemplary system for communicating content and data to a client device. In some embodiments, FIG. 1B provides more detail for application server 150, network servers 145 and stream content servers 147 in FIG. 1A. Like reference numbers represent the same elements, for example application server 150 in FIG. 1B represents application server 150 in FIG. 1A, local data servers 145a and 145b represent network servers 145 in FIG. 1A, and streaming content server 147a and streaming servers 147b-c represent stream content servers 147 in FIG. 1A.

Application server 150 can communicate with local data servers 145a-b and streaming content host 147a. Application server 150 can communicate with local data servers 145a-b to exchange data, transactions and events associated with a user or client device in communication with a particular data server. Application server 150 can communicate with streaming content host to provide media content and advertisement content. The streaming content host can communicate with streaming servers 147b-c to communicate the content for distribution to client devices in communication with each particular streaming server.

In some embodiments, the functionality of the platform of the current technology is partitioned between application server 150 and local data servers 145a-b based on performance, quality-of-service and computational requirements. Additionally, the multimedia content is centrally managed at Streaming Content Host 147a which supports replication of the content at the edge streaming servers 147b-c based on aggregated potential demand at local data servers 145a-b. Each local data servers may serve client devices in multiple IP domains (or geographical regions, or other spatio-temporal partitions). A collection of such client devices communicates with a preassigned local data server (that is determined during the initial provisioning phase of client device registration and initialization). Furthermore, each local data server also maintains knowledge of the edge streaming servers that serve content to client devices which communicate with the particular local data server.

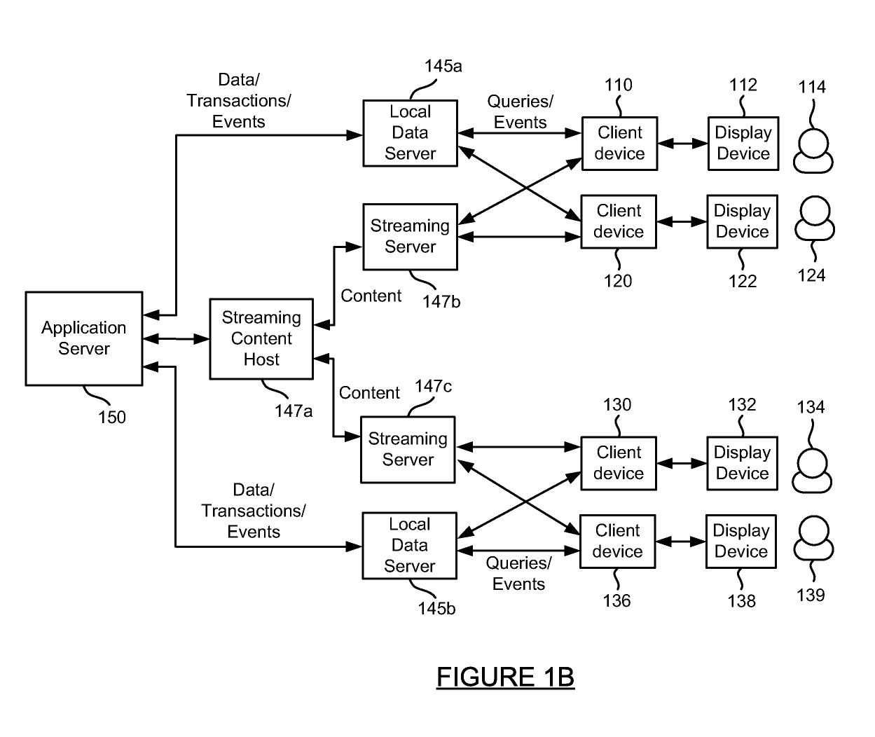

FIG. 2 is a flow chart of an exemplary method for providing content to a user. A user account is created from received user input at step 210. Application server 150 can create a user account from user data received from any of client device 104 or client device s 110-130 over network 140. For example, a user may create an account through a web portal provide by application server 150 and network servers 145 through web browser 106 (for example, “Internet Explorer” by Microsoft Corporation, of Redmond, Wash.) on client device 104. The user data may include demographic information, user preferences, and other user data. User data received may be stored for the user at user data store 180 by application server 150.

After creating a user account, the entertainment service is initialized for the user at step 220. Initialization may include establishing a connection with a client device 110, for example a client device which comprises a set top box, by application server 150 or network server 145 over network 140. The initialization may include registering the client device with an account, identifying a local data server and streaming server to serve the client device, and collecting connection and location information for the client device, and other tasks.

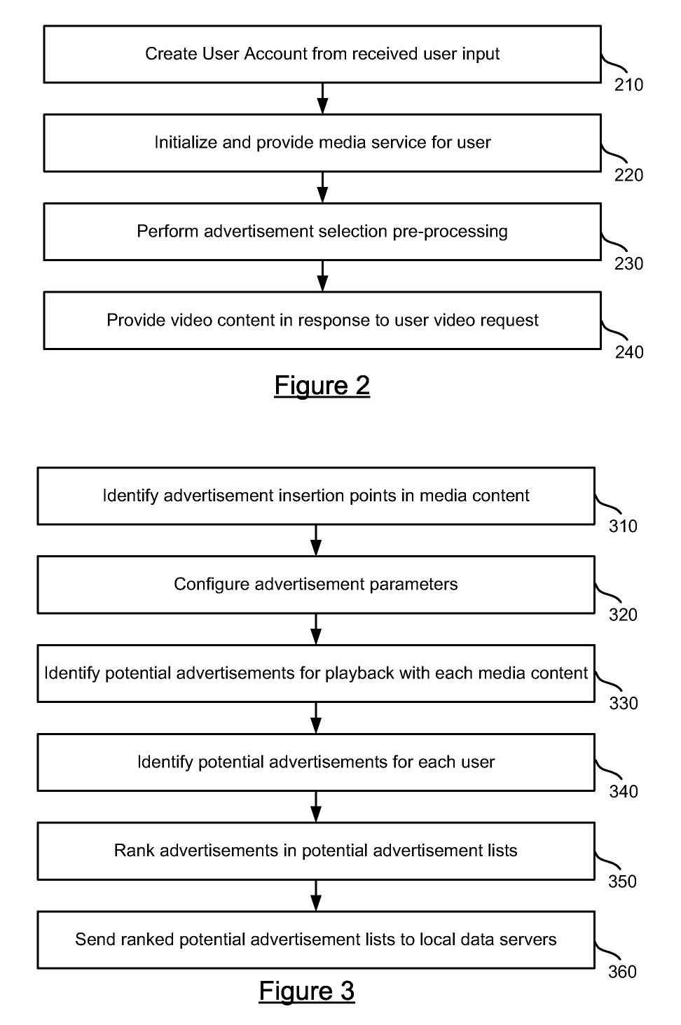

Pre-processing is performed for the dynamic ad selection at step 230. Pre-processing may involve identifying advertisements that correspond to different media content and to users, identifying content insertion points, and other processing. Pre-processing some of the operations required in selecting ads to place in requested content helps the system provide requested content in near real time. In some embodiments, the pre-processing may be performed periodically, based on events such as the addition of a new user or media content, or based on some other event by the system of FIG. 1B. Pre-processing for dynamic ad selection is discussed in more detail with respect to the method of FIG. 3 below.

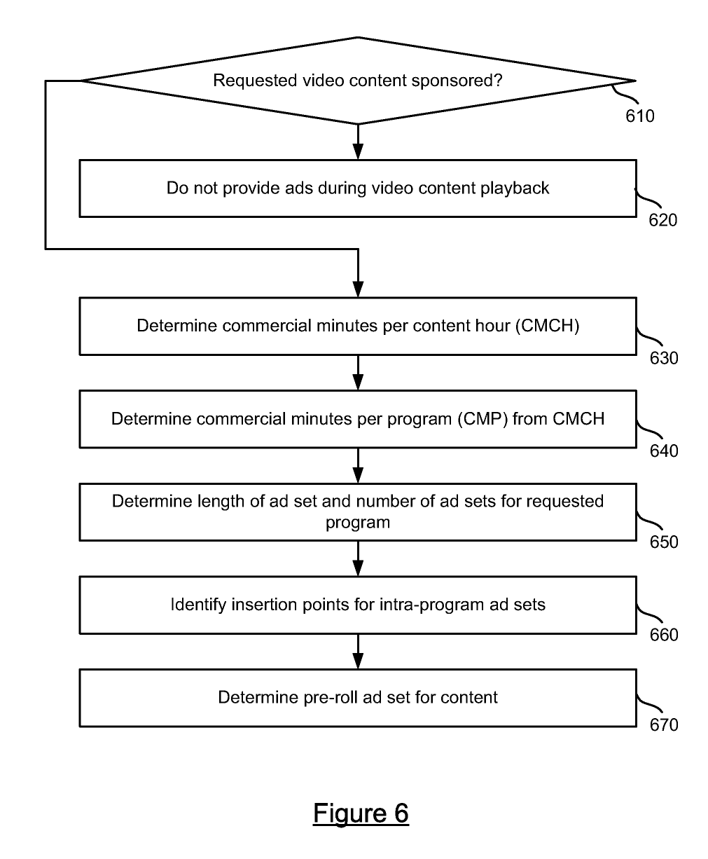

Video content can be provided in response to the user video request at step 240. A request for video or other media may be received by application server 150 from client device 110. A user may initiate the request by navigating a user interface provided by client device 110. While navigating the user interface, the user may browse media content information, search for specific or suggested media, and provide a selection for media. Client device 110 can transmit the request for the video content to application server 150 over network 140 and network servers 145. The request may be received and processed by application server 150 along with elements in the system of FIG. 1B, and the requested content can be provided to client device 110 by application server 150 through streaming content host 147a and streaming servers 147b-c in response to the request. In some embodiments, one or more selected advertisements can be dynamically selected and inserted into the selected video content provided to the user. Client device 110 may receive and playback the requested content, including the requested media and one or more selected advertisements. Providing video content in response to a user video request is discussed in more detail below with respect to FIG. 6.

As media is provided to a user, user behavior in playing the media can be logged and transmitted to application server 150 via local data server 145a by client device 110. For example, user behavior such as fast forwarding, pausing, rewinding, and other user actions during playback can be recorded. The user behavior data is stored by application server 150 to user data store 180 and can be retrieved when selecting subsequent ads to provide to the user. Additionally, data regarding the playback of advertisements and requested content can also be transmitted by client device 110 through a local data server 145a to application server 150. Monitoring, logging and management of user behavior data is further described in U.S. patent application Ser. No. 12/390,308, entitled “Media Based Entertainment Service,” filed on Feb. 20, 2009, the disclosure of which is incorporated herein by reference

FIG. 3 is a flow chart of an exemplary method for performing advertisement selection pre-processing. The method of FIG. 3 provides more detail for step 230 in the method of FIG. 2 and can be implemented by the system of FIG. 1B. First advertisement insertion points are identified in media content at step 310. The insertion points are points in media content at which an ad set or ad “pod” may be inserted into the content.

Ad insertion time-points may be predefined for TV shows delivered on broadcast networks or movies produced for TV. Such time points may be available with the content in digital form. Alternatively, automated video processing tools may be used to determine ad insertion points based on analysis of the digital media content. For example, specific ad insertion cues may include: a) fade to blacks (or uniform colors), b) silence spots, c) scene changes (cuts)—defined by locational change, palette changes, introduction of new actors, d) changes in background levels, and so forth. Potential additional cues include a) changes in closed captioning text, b) face/on-screen object/on-screen text/on-screen product/logo recognition to trigger ad points or overlay advertisements, and c) detection of different types of relevant “scene change” features.

In some embodiments, media content may be received by the entertainment system as “cut” (or appropriately slugged) and prepared for ad insertion by the content providers. Considerations for time point selection may include: a) the temporal duration between two consecutive ad insertion points can be spaced far enough for good viewing experience, such as evenly throughout the media content, and b) should have cues such that contextually relevant ads may be inserted. For example, ad points in the middle of car chases could include ads for sports cars and should be tagged accordingly.

Advertisement parameters are configured at step 320. The ad parameters specify how ads can be incorporated into a particular media file by media processing module 152 of application server 150. The parameters can indicate user demographic information such as user gender, geographic location, income level, marriage status, or other user demographic data, user viewing behavior, purchase behavior, the local time of the viewer, the current physical location of the viewer, and other user data. The ad parameters may also specify content categories, brand adjacency restrictions which prevent ads having a particular advertiser or brand to be positioned in the same ad set or in sequence, frequency requirements, cost information, temporal requirements, location information and other rules for providing the ad to a user within media content. In some embodiments, ad parameters may be specified by an advertiser, content provider, or other entity and stored as ad parameters 174 in ad server 170. Application server 150 can access and manage the ad parameters 174.

A list of potential ads to playback for each media content is identified at step 330. For each media content element, a list of available ads and corresponding ad parameters for each ad are accessed, and the ads that can potentially be played back for each content element are identified in a list for the content. For example, for one hundred movies available for request by a user, there will be a list of potential ads customized for each movie, resulting in one hundred potential ad play back lists for the set of media. An ad may be added to a potential list of ads if the ad parameters for the advertisement do not prevent it from being played back with the content. The ads may not actually be played back during playback of the media based on other restrictions, for example if they are barred by user preferences, if parameters prevent them being shown to a user which requests the content, or based on some other parameter.

A list of potential ads to playback for each user is identified at step 340. Similar to the media potential playback ad lists, a potential ad list for a user is a list of all the ads that may be played back for the user. The ad list may comprise ads that match user preferences and for which the ad parameters do not preclude the ads from being played back for the particular user. The ads may not actually be played back during for the user based on other restrictions, for example if the ads have parameters that prevent the ad from being shown by content selected by the user.

The potential ad lists for each user and media content are ranked at step 350. The ranking may be performed based on of advertisement value, contract requirements or other business rules implemented by the entertainment service, or other factors. For example, the value of the advertisement may be normalized such that the value of each ad per 30 seconds is determined, and ranked accordingly. In some embodiments, a CPM (cost per thousand) rate may be used to sort ads, that is the revenue that may be generated for each view of the ad as ranking factor.

Sometimes, an ad may have a different value depending on where the ad is placed within an ad set or “pod.” For such ads, both values may be considered when ranking the ad or alternate rankings may be maintained for the ads (one for each value of the ad). Thus, there may be two rank lists for every ad, one for premium positions (first and last in a pod) and another for all other positions. The ads rankings may also reflect an obligation to playback a particular ad a minimum number of times during a time period.

The ranked list of ads is transmitted to local data servers at step 360 by application server 150. Application server provides the ranked ads list for potential user advertisements and potential content advertisements to allow the ad lists to be easily accessible by the servers which process client device requests. In some embodiments, a local data server may only receive ads list for potential user advertisements for users which are served by the local data server. Thus, local data server 145a would only receive ads list for potential user advertisements for users of client devices 110 and 120. Similarly, a local data store may only receive ads list for potential content advertisements for content that would be provided to a display device served by the local server. For example, for a content X only provided in country B, the advertisement lists for content X would not be provided to local data servers that only serve clients outside of country B.

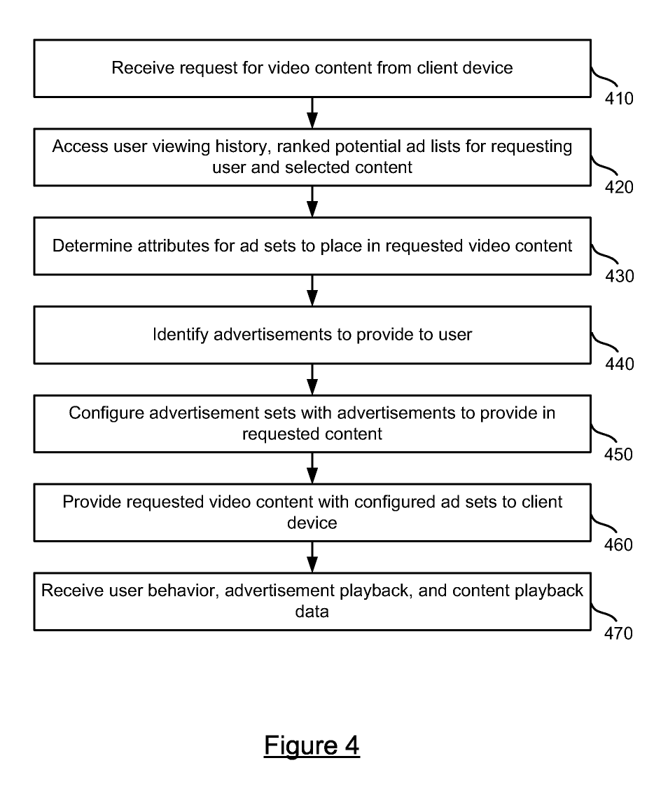

FIG. 4 is a flow chart of an exemplary method for providing content to a user at runtime. The method of FIG. 4 provides more detail for step 230 of the method of FIG. 2. Though the method of FIG. 4 is discussed with respect to a request for video media, the method may be applied to any type of media request. First, a request for video content can be received from client device 110 at step 410. In some embodiments, the request is received by local data server 145a from client device 110, and the request is forwarded to application server 150.

Local data server 145a then accesses recent user viewing history, the most recent ranked advertisement lists for the requesting user and the content requested at step 420. The user viewing history can be accessed from application server 150 if they are not already stored by local data server 145a.

Attributes for ad sets to place within a requested video may be determined at step 430. The attributes can specify features of an ad set or “pod” to insert in the media content, wherein example features include the number of ad sets, the ad set duration, the insertion points within the video content, and other data. Determining attributes for ad sets to place in the requested video content is discussed in more detail below with respect to FIG. 6.

Ads can be identified to place in the requested video content at step 440. The identified ads are selected from the potential ad lists accessed at step 420. For the ranked ad list of potential ads for the user, ads are removed from the list if advertisement parameters prevent the ads from being displayed for the selected content, the time of day the content will be played, or based on other information that is known after the user selects content for playback. For the ranked ad list of potential ads for the selected content, ads are removed from the list if advertisement parameters prevent the ads from being displayed for the user selecting the content, the time of day the content will be played, or based on other information that is known after the user selects the content for playback. The remaining ads in the ad lists are then concatenated together such that the ad list with ads for the user are listed before the ads in the ad list for the content. In some embodiments, two final lists are generated which cover ads appearing in the first or last slot in an ad set and ads appearing between the first and last slot in an ad set.

The ad sets are configured, or populated, with advertisements to provide in the requested content at step 440. Put another way, the ad sets identified in step 430 are filled with ads identified in step 440. Step 440 is done in real time from information in the user request and the information resulting from the pre-processing. Configuring ad sets with identified ads is discussed in more detail below.

Configuring advertisement sets with advertisements can be complex and computationally costly if a large number of advertisements are processed (such as 1000 ads with various relationships amongst each other). In some embodiments, step 450 can be performed using a technique of dynamic constraint satisfaction that interleaves constraint satisfaction with optimization. The playlist generation problem can be modeled as a product configuration problem, wherein compatible components are selected to form an assembly that meets a set of requirements. In conventional approaches to product configuration, a system must test the compatibility between components in an iterative manner, which incurs exponential costs as the number of components to consider increases.

Constraints can be represented in, for example, Ordered Boolean Decision Diagrams. By canonically representing constraints in terms of Ordered Boolean Decision Diagrams (OBDD), the constraints can be compiled into truth-tables and efficiently processed at runtime. OBDDs are efficient computational representations of boolean functions. Compilation of the constraints allows the present system to avoid back-tracking problems (of testing alternative choices of components) and simultaneously in a single pass of the compiled OBDD obtain the current feasible choices of values for a decision variable. The present system models ads as components and represents logical relationships between ads, content and viewers in terms of OBDDs. Selection of an ad to fill a pod updates the relationships and generates a new set of feasible ads that may be considered next. From this new feasible set, an ad is selected that potentially maximizes revenue, inject its constraints into the compiled BDD and the process is repeated to obtain the next feasible set.

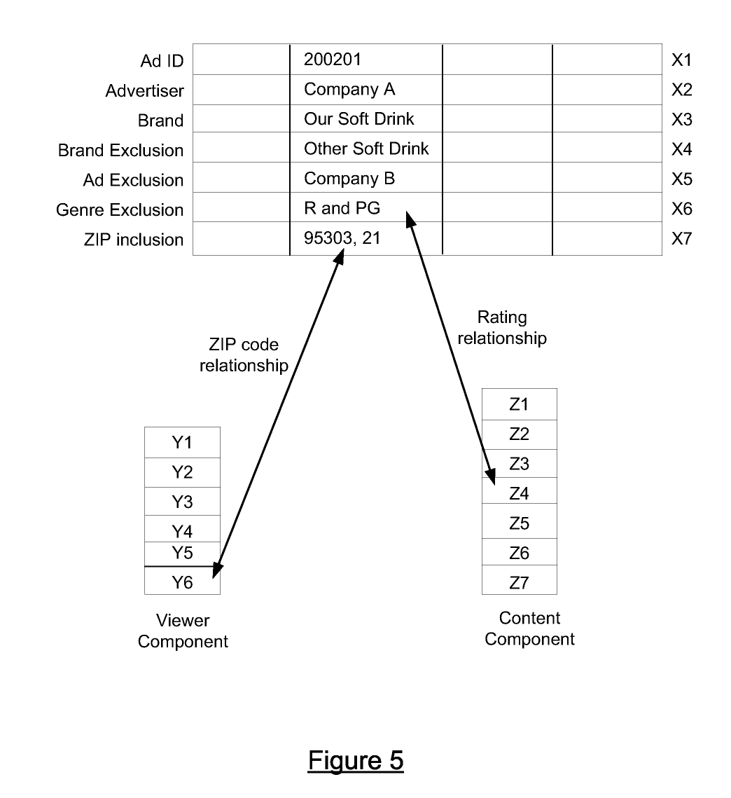

FIG. 5 illustrates a logical representation of an ad set configuration. The logical representation illustrates an ad set with slots for advertisement components. In some embodiments, an ad set may have sixteen ad slots, though four slots are illustrated in the ad set in FIG. 5. Each slot may be filled by an ad. For example, slot 2 is filled with an ad from advertiser Company A. Further, different attributes are provided for each slot which takes on values of the particular ad that occupies the slot. Additionally, the figure illustrates two additional components, which lie outside the basic ad set, namely a viewer component and a content component, which have attributes. For purposes of modeling, the variables of the ads can be notated as xij, where i is the slot number and j is the attribute. Slot numbers run from 0 to F (in hex notation). Similarly, the viewer attributes are notated yk and the content attributes are notated, zm. The arrows between the ad set and other components indicate that these attributes are constrained, namely either they are equal, or belong to common set of values, or have some logical relationship. Selecting the ad in slot 2 imposes a number of constraints. In some embodiments, the cells X4 through X7 represent what can be configured as either an inclusion or an exclusion. Moreover, a cell can be use for genre exclusion/inclusion (i.e. ×8), for example an exclusion of for content associated with “Thriller” media.

For example, one constraint between the ad and the content is that the ad should not run against R and PG rated content. Similarly, a constraint between the ad and the viewer is that the ad should be shown in only certain zip codes. Further, a constraint can indicate that ads must not be repeated. Similarly, the brand exclusion constraint may also indicate that a “Other Soft Drink” brand should not follow a “Our Soft Drink” brand product. This ensures that the remaining slots should not be filled with ads from the Other Soft Drink brand. The task of ad insertion is to populate the ad set satisfying relationships between all the entities. Initially, the ad set is empty; viewer and content components are initialized. The total pool of available ads (components) is the union of the two lists of ads (one for the viewer and another for the content) which have been created during the pre-processing stage. This pool of ads is sorted by the ranking functions and organized into two lists. The first slot in the pod is populated with the top ranked ad from the premium list, and constraints are checked between the ad, viewer and content components. If these constraints are satisfied, additional constraints based on the inserted ad are imposed on the remaining slots of the ad set (that is on other ads).

Once these constraints are established, the original pool of ads may be filtered for all the feasible ads (conventional math programming techniques may not apply). The choice of an ad dictates what other ads remain for consideration. This filtering is a costly process, and may benefit from using OBDD-based representation (discussed below) which ameliorates the computational costs. The remaining set of ads is re-ranked, the next component ad is selected, inserted into the ad set, and the insertion process continues till the limits on total pod duration are met. If a selected ad is inserted into the pod and its constraints are not satisfied (rather are in conflict with the viewer and content components), the OBDD-based framework will indicate that the component cannot be inserted.

Constraints may be introduced into two ways: a) when an ad is selected for insertion and is inserted successfully, it may impose constraints on other ads, and b) constraints may also be introduced by/on an ad when it is being selected for insertion. These two ways may introduce constraints on different attributes. For example, an ad already selected may introduce a constraint on the advertisers of the remaining ads. One of the remaining ads may introduce a constraint on the brands of ads already in the pod. Thus both sets of constraints need to be checked. If an ad fails insertion (because it is incompatible with ads already inserted), we skip that ad and try the next ad in the feasible set. However, note that this process is not backtracking, an ad once tried may not be tried again in the same pod (because most preferred ads from the pool are inserted, an ad once inserted is usually not taken out, and taking an ad out may potentially reduce revenue).

A configuration problem C can be encoded efficiently in terms of boolean variables and functions. For each variable above, the xij, yk and zm variables, each variable can take a set of values from a finite domain D. A single brand value associated with an ad brand variable will be represented by an AND expression similar to the above for 16 bits. For example, if the value is the 4th value, the last two bits will be 1 and all the other higher order bits will be 0 to indicate that the variable has this 4th value. Thus, a variable that can take multiple values is an implicitly ORed expression of individual AND expressions (one for each bit sequence). Furthermore, the different constraints can also be expressed in terms of logical expressions. For example, if a variable can take only a specific value, only that specific bit sequence is allowed (expressed as a boolean function). Alternatively, a not equals constraint can be represented as a negated boolean function for those values that are disallowed. Assuming that there are no constraints on any variable, the solution space of the configuration problem is the ANDed set of all boolean functions of all valid values for the problem variables.

As constraints are defined between variables, additional expressions that assign specific values to variables are ANDed to the initial set and constrain the potential set of values. The solution to the configuration problem is an assignment of values to the boolean variables that makes the ANDed expression true. Finding all valid feasible assignments is an NP-complete problem in the general case. A common method used to represent such complex boolean functions is the reduced Ordered Binary Decision Diagram (OBDD), which is a rooted directed acyclic graph representing a boolean function on a set of linearly ordered variables. It has one or two terminal nodes (labeled 1 or 0) and a set of variable nodes. Each variable node is associated with a boolean variable and has two branches (low and high, denoting a 0 and 1). Given an assignment of the variables, the value of the boolean function is determined by a path starting from the root node and recursively following the high edge if the variable value is 1 or the low edge if the value is 0. The function value is 1 if the reached terminal node is 1, else it is false. Alternatively, any path reaching terminal node 1 assigns corresponding values to the variables on the path to make the function true and thus solve the satisfiability problem. Alternatively the path reaching terminal node 0 provide an assignment that makes the function false and satisfy the complement of the boolean function. Reduced OBDDs are a canonical representation and provide a number of good computational properties.

In the ad insertion problem, an initial OBDD representation is built based on the structure of the ad set, the viewer and content components. Their attributes and corresponding values are translated into corresponding boolean expressions and compiled. For this purpose, we define a mapping function T that converts a propositional expression φ to the boolean function it represents:

$$τ ( φ ) : {π}_{i = 1}^{n} {B}^{ln} B$$

Further this mapping is defined inductively as follows:

τ(xᵢ=v)≡(bᵢ=v)

τ(φΛψ)≡τ(φ)Λτ(ψ)

τ(φVψ)≡τ(φ) Vτ(ψ)

τ(φ [symbol] )≡ [symbol] τ(φ)

When an ad is inserted into the ad set, its values are compiled into a set of boolean expressions (one for each attribute and its values) and added to the initial OBDD. Then we attempt to find at least one assignment of values to the variables that satisfies the overall expression, that is a valid path to terminal 1 exists. If it does the assignment is considered valid and that ad can be inserted. If no valid path can be found to terminal node 1, that ad is rejected and the next ad is considered. If an ad is inserted, its constraints are added as additional boolean expressions to the OBDD which is updated, before the next ad can be inserted.

One example of a basic algorithm for configuring ad sets with advertisements using OBDD proceeds as follows. While the total ad set duration is less than the maximum ad set length, the present system selects an ad from a ranked list(s) of feasible ads and inserts the selected ad into a first remaining slot. The validity of assignment is checked using OBDD operations as discussed above. If the assignment is successful, new constraints are introduced from the ad into OBDD and the feasible set of ads remaining is then determined. If the assignment is not feasible, the present system rejects the ad and selects the next ad in the ranking list. The process continues to determine the validity of the assignment of the current selected ad. Once an ad assignment is feasible, the remaining ads are re-ranked and the next ad is selected per above. Once the ad set duration limit is reached, all the ads are returned to ad set and the next ad set, if any, is configured.

Returning to the method of FIG. 4, after configuring the ad sets with identified ads, the requested media content with the configured ad sets are provided to client device 110 by at step 480. The requested media content and system selected advertisements can be provided via a media stream by stream content server 147, a single file download by application server 150 or servers 147, or some other method to client device 110. When provided as streaming content, local data server may provide the requesting client device with a list of uniform resource identifiers (URI) that identify portions of content. For example, a list of provided URIs may identify, in order, each advertisement in a pre-roll ad set, a first portion of the requested media up until the first intra-content ad set, each advertisement in the first intra-content ad set, a first portion of the requested media up until the second intra-content ad set, and so on until the last URI indicates that last ad or requested media content. Each URI identifies a location from which the corresponding advertisement or requested media content can be found. Client device 110 reads each URI, requests the corresponding content from the location identified by the URI, such as a particular streaming server, and provides the content as it is streamed to client device 110 from the content location.

User behavior data, ad completion data and content completion data is provided to local data server 145a from client device 110 at step 470. Whenever the viewer completes watching an ad, events are sent back to the local data server. These events can be used for tracking the number of views, consuming budgets and updating the campaign statistics. Furthermore, the system of the present technology dynamically filters the list of currently applicable ads by removing all ads that have been viewed in a given time horizon into the past from the current time. Instead of generating all the segments of the playlist dynamically, the system may generate subsets of the playlists and accommodate constraints from ads watched to obtain a more dynamic and reactive interaction with the viewer. Furthermore, such a dynamic capability will provide better revenue management of the ads. Once all the URIs are viewed or the user asynchronously stops the playlist, the client device returns to its normal browsing mode.

FIG. 6 is a flow chart of an embodiment of a method for determining ad set attributes. In some embodiments, the method of FIG. 6 provides more detail for step 330 of the method of FIG. 3. A determination is made at step 610 as to whether media content requested by client device 110 is sponsored. Content that is sponsored may not require ads be inserted into the content but only have a pre-roll pod. For example, an action movie with one or more car chases might be sponsored by a car company with that company's car ads in the pre-roll pod. If requested video content is sponsored, then ads may not be provided during the video content playback as indicated at step 620. If requested video content is not sponsored, the advertisement minutes per content hour for the requested media content is determined at step 630. In some embodiments, the number of commercial minutes to insert for each hour of content of the requested content may be fixed, such as 14 minutes per content hour. In some embodiments, the commercial minutes per content hour may be based on the cost of the program, the value to the viewer, and the value of the advertisement itself.

The commercial minutes per program are determined from the commercial minutes per content hour at step 640. In some embodiments, commercial minutes per program may be determined as the length of the program in minutes divided by 60 and then multiplied by the commercial minutes per content hour determined at step 630.

A length of the ad set and the number of ad sets for requested content is determined for the requested content at step 650. In some embodiments, an ad set length may be fixed at some length plus or minus a period of time. For example, an ad set may be fixed at 2 minutes and 37 seconds plus or minus 23 seconds. A number of ad sets may also be determined based on the commercial minutes per program per length of content or as a fixed value, for example three ads per 20 minutes of content.

Insertion points for intra-program ad sets are identified at step 660. The insertion points may be identified manually or using digital processing techniques. Several insertion points may be identified for a particular program. Typically, the content insertion points used will include the first insertion point and a number of additional insertion points. In some embodiments, when the number of insertion points is not equal to the number of ad sets to be inserted, a series of rules may determine how many ad sets are included within the content. If the number of insertion points is greater than the number of ad sets, the first insertion point is used and the remaining ad sets are spaced throughout the media content as equally as possible. If the insertion points available are less than the total number of ad sets, then the number of ad sets used is the number of insertion points and at least one ad set is discarded.

Whether to include a pre-roll ad set for the content may be determined for the requested video content at step 670. In some embodiments, a pre-roll may optionally be provided before playback of the requested video content. For example, a pre-roll might only be provided for requested content if the content is a movie. In this example, if the requested content is not a movie, there will not be a pre-roll of advertisements provided before the movie.

In addition to the above discussed technology, the present system may include tools that are provided to advertisers to manage their campaigns. For a campaign to be effective from an advertiser point of view, it has to be targeted at the correct audience and replayed a certain number of times to reinforce the message. In addition, certain advertisements can have time element to it, in that it expects people to react to the message within a specific time. Advertisements can be targeted at a regional level or at the national level.

The advertising system will provide to the advertiser necessary tools to identify target market and its size. Based on the our subscriber profiles, interests and preferences, our system can help advertisers identify markets for their products. This will allow the advertiser to define their campaign parameters including but not limited to geographical location, time, profile of the users and the content that must be targeted.

The system will also provide feedback to the advertisers in near real time on the performance of their campaign. Who watched it, where and in what context. The content is the content that carried the advertisement. This will allow the advertisers to adjust their campaign parameters based on the response. The system will make sure the new parameters are propagated through the system in near real time to enforce the changed set of constraints.

The system will be managing multiple campaigns, with different constraints which are dynamic. The inventory of the remaining number of views that needs to be served will be maintained by the system. The remaining views will also control the campaign is prioritized within the system.

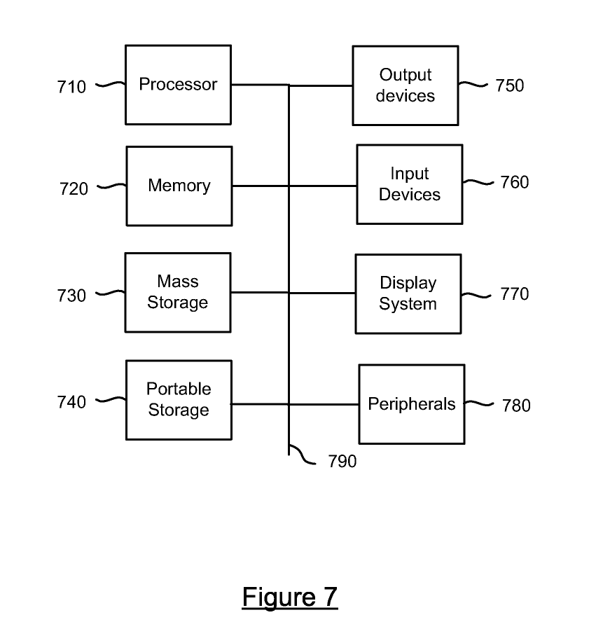

FIG. 7 is a block diagram of an exemplary computing device for implementing an interactive entertainment service environment. In some embodiments, the exemplary computing device of FIG. 7 may be used to implement client devices 104 and 70-130, network server 145, application server 150, media server 160, ad server 180, user data store 180, merchant server 190 and financial services server 192.

The computing system 700 of FIG. 7 includes one or more processors 710 and memory 720. Main memory 720 stores, in part, instructions and data for execution by processor 710. Main memory 720 can store the executable code when in operation. The system 700 of FIG. 7 further includes a mass storage device 730, portable storage medium drive(s) 740, output devices 750, user input devices 760, a graphics display 770, and peripheral devices 780.

The components shown in FIG. 7 are depicted as being connected via a single bus 790. However, the components may be connected through one or more data transport means. For example, processor unit 710 and main memory 720 may be connected via a local microprocessor bus, and the mass storage device 730, peripheral device(s) 780, portable storage device 740, and display system 770 may be connected via one or more input/output (I/O) buses.

Mass storage device 730, which may be implemented with a magnetic disk drive or an optical disk drive, is a non-volatile storage device for storing data and instructions for use by processor unit 710. Mass storage device 730 can store the system software for implementing embodiments of the present invention for purposes of loading that software into main memory 720.

Portable storage device 740 operates in conjunction with a portable non-volatile storage medium, such as a floppy disk, compact disk or Digital video disc, to input and output data and code to and from the computer system 700 of FIG. 7. The system software for implementing embodiments of the present invention may be stored on such a portable medium and input to the computer system 700 via the portable storage device 740.

Input devices 760 provide a portion of a user interface. Input devices 760 may include an alpha-numeric keypad, such as a keyboard, for inputting alpha-numeric and other information, or a pointing device, such as a mouse, a trackball, stylus, or cursor direction keys. Additionally, the system 700 as shown in FIG. 7 includes output devices 750. Examples of suitable output devices include speakers, printers, network interfaces, and monitors.

Display system 770 may include a CRT, a liquid crystal display (LCD) or other suitable display device. Display system 770 receives textual and graphical information, and processes the information for output to the display device.

Peripherals 780 may include any type of computer support device to add additional functionality to the computer system. For example, peripheral device(s) 780 may include a modem or a router.

The components contained in the computer system 700 of FIG. 7 are those typically found in computer systems that may be suitable for use with embodiments of the present invention and are intended to represent a broad category of such computer components that are well known in the art. Thus, the computer system 700 of FIG. 7 can be a personal computer, hand held computing device, telephone, mobile computing device, workstation, server, minicomputer, mainframe computer, or any other computing device. The computer can also include different bus configurations, networked platforms, multi-processor platforms, etc. Various operating systems can be used including Unix, Linux, Windows, Macintosh OS, Palm OS, and other suitable operating systems.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claims appended hereto.

What is claimed is:

1. A computer implemented method for providing media to a client device, comprising:
identifying potential ads by an application server for each user in a set of users;
identifying potential ads by the application server for each media content in a set of media content;
receiving a request for media content from a client device by an application server;
identifying a subset of the potential ads based on the media content request received from the client; and
providing the requested content and the subset of potential ads to the client device.

2. The computer implemented method of claim 1, further comprising configuring ad set parameters by the application server for each media content in the set of media content, wherein the subset of potential ads is provided in one or more ad sets.

3. The computer implemented method of claim 1, wherein said identifying potential ads for each user, identifying potential ads for each media content, and configuring ad set parameters is performed before receiving the request.

4. The computer implemented method of claim 1, wherein identifying a subset includes identifying a first group of ads as the potential ads for a user associated with the client device which correspond to the requested content;

5. The computer implemented method of claim 1, wherein identifying a subset includes identifying a second group of ads as the potential ads for a content which correspond to the user associated with the client device;

6. The computer implemented method of claim 1, wherein said step of identifying a subset of ads is performed by a server using truth tables of boolean functions for representing relationships.

7. The computer implemented method of claim 1, wherein said step of identifying a subset of ads is performed by a server and based on boolean functions on a set of linearly ordered variables.

8. The computer implemented method of claim 1, wherein providing the requested content and subset of potential ads includes providing a uniform resource identifier to the client device for each advertisement in the subset of potential ads.

9. The computer implemented method of claim 1, wherein providing the requested content and subset of potential ads includes providing one or more uniform resource identifiers to the client device for requested media content.

10. The computer implemented method of claim 1, wherein providing the requested content and subset of potential ads includes providing a list of uniform resource identifiers to the client device, the uniform resource identifiers configured to enable the client device to receive a stream the requested content and subset of potential ads.

11. The computer implemented method of claim 1, further comprising receiving advertisement playback data from the client device.

12. The computer implemented method of claim 1, further comprising receiving media content playback data from the client device.

13. The computer implemented method of claim 1, further comprising receiving user activity data from the client device.

14. A computer readable storage medium having embodied thereon a program, the program being executable by a processor to perform a method for providing media, the method comprising:
identifying potential ads by an application server for each user in a set of users;
identifying potential ads by the application server for each media content in a set of media content;
receiving a request for media content from a client device by an application server;
identifying a subset of the potential ads based on the media content request received from the client; and
providing the requested content and the subset of potential ads to the client device.

15. The computer readable storage medium of claim 14, further comprising configuring ad set parameters by the application server for each media content in the set of media content, wherein the subset of potential ads is provided in one or more ad sets.

16. The computer readable storage medium of claim 14, wherein said identifying potential ads for each user, identifying potential ads for each media content, and configuring ad set parameters is performed before receiving the request.

17. The computer readable storage medium of claim 14, wherein identifying a subset includes identifying a first group of ads as the potential ads for a user associated with the client device which correspond to the requested content;

18. The computer readable storage medium of claim 14, wherein identifying a subset includes identifying a second group of ads as the potential ads for a content which correspond to the user associated with the client device;

19. The computer readable storage medium of claim 14, wherein said step of identifying a subset of ads is performed by a server using truth tables of boolean functions for representing relationships.

20. The computer readable storage medium of claim 14, wherein said step of identifying a subset of ads is performed by a server and based on boolean functions on a set of linearly ordered variables.

21. The computer readable storage medium of claim 14, wherein providing the requested content and subset of potential ads includes providing a uniform resource identifier to the client device for each advertisement in the subset of potential ads.

22. The computer readable storage medium of claim 14, wherein providing the requested content and subset of potential ads includes providing one or more uniform resource identifiers to the client device for requested media content.

23. The computer readable storage medium of claim 14, wherein providing the requested content and subset of potential ads includes providing a list of uniform resource identifiers to the client device, the uniform resource identifiers configured to enable the client device to receive a stream the requested content and subset of potential ads.

24. The computer readable storage medium of claim 14, further comprising receiving advertisement playback data from the client device.

25. The computer readable storage medium of claim 14, further comprising receiving media content playback data from the client device.

26. The computer readable storage medium of claim 14, further comprising receiving user activity data from the client device.

27. A system for providing media to a client device, comprising:
an application server able to receive media content and transmit the media content to at least one server of the plurality of media streaming servers;
a plurality of media streaming servers coupled to the application server and a client device, the media streaming servers configured to stream media content in response to receiving a media content request from a client device;
a local data server coupled to the application server, the local data server configured to receive media data, ad data and user data from the client device,
the local data server configured to insert selected advertisements into requested media content based on ordered binary decision diagrams.

28. The system of claim 27, the media streaming servers storing content associated with a uniform resource identifier (URI), the requests received by the media streaming servers associated with the URI.

29. The system of claim 27, the application server able to identify potential ads for the client device before the client device submits a request for media content.

30. The system of claim 27, the application server able to identify potential ads to provide with requested media content before the client device submits a request for the media content.

31. The system of claim 27, the application server able to configure ad set attributes for ad sets to incorporate with media content before the client device submits a request for the media content.
